(19) United States
(12) Patent Application Publication
(10) Pub. No.: US 2009/0011323 A1
(43) Pub. Date: Jan. 8, 2009

(54) Solid Oxide Electrochemical Devices Having an Improved Electrode

(75) Inventors: Jie Guan, Torrance, CA (US); Rajiv Doshi, Torrance, CA (US); Atul Kumar Verma, Westford, MA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/773,713

(22) Filed: Jul. 5, 2007

(51) Int. Cl. H01M 4/86; H01M 4/88

(52) U.S. Cl. 429/41; 29/623.1; 429/219; 429/220; 429/221; 429/223; 429/224; 429/231.5; 429/44

(57) ABSTRACT

An electrode with improved resistance to Cr poisoning comprising AₓB₃₋ₓO₄, wherein A is selected from the group consisting of Mn, Co, Fe, Cr, Cu, V, and Ni and B is selected from the group consisting of Mn, Co, Fe, Cr, Cu, V, and Ni and a solid oxide electrochemical device comprising the same. A method for making a solid oxide electrochemical device comprising the above-described electrode.

### TECHNICAL FIELD

This invention relates to solid oxide electrochemical devices. In particular, this invention relates to solid oxide electrochemical devices having an electrode with reduced degradation rate and improved compatibility with stack components.

### BACKGROUND OF THE INVENTION

Solid oxide electrochemical devices have demonstrated great potential for future power generation with high efficiency and low emission. Such solid oxide electrochemical devices include solid oxide fuel cells (SOFCs), solid oxide electrolyzers, and electrochemical pumps.

In an SOFC, stacks of repeatable modular assemblies, each of which is capable of generating a small amount of power, are connected together. Each stack unit is connected to its neighboring unit with an interconnect module, which serves as both a current collector and a channel for flowing gases to the electrodes.

Both ceramic and metallic interconnects may be used as the interconnects in an SOFC. Ceramic interconnects are more suitable for high temperature SOFCs due to their relatively low electrical conductivity; however, reduction of SOFC operating temperatures to an intermediate range of approximately 700° C.-800° C. has made it feasible to use metals or alloys as interconnect materials.

Metallic interconnects offer numerous advantages over ceramic interconnects, including higher electrical conductivity, high thermal conductivity, low cost, and excellent ease of fabrication. Despite these numerous advantages, most metallic interconnect materials are vulnerable to oxidation, especially when exposed to the typical SOFC operating conditions: high temperatures, oxidizing and reducing atmospheres, and presence of steam. Alloys of interest for use in metallic interconnects include Ni-, Fe-, and Co-based super alloys, Cr-based alloys, and stainless steels because of their fair oxidation resistance and similar coefficients of thermal expansion with other stack components. These alloys typically have sufficient levels of Cr and/or Al to protect against the oxidation and corrosion of the metallic interconnect.

Oxidation of metal generally forms a resistive oxide scale that increases in thickness over time, causing SOFC performance decay due to increasing ohmic resistance. With the use of chromium (Cr)-containing alloys, formation of Cr-containing oxide scale can also detrimentally impact SOFC performance by what is commonly called “Cr poisoning.”

While the exact mechanism of Cr poisoning to the SOFC cathode remains unclear, it is generally accepted that the Cr₂O₃ scale formed on the surface of the metallic interconnect reacts with the moisture and oxygen in the gas stream to form volatile compounds such as CrO₃ and CrO₂(OH)₂. The latter of these compounds reduces to form precipitate Cr₂O₃ and may also react with cathode materials at the cathode/electrolyte interface, resulting in cathode performance decay.

Many attempts have been made to prevent Cr poisoning. One approach focused on the development of superior alloys and surface modification of the metallic interconnects to form conductive but less reactive and volatile oxide scales. Another approach used protective conductive barrier coatings over the metallic interconnect to reduce Cr reactivity and volatility. These coatings were used in conjunction with traditional perovskite cathode materials such as strontium doped lanthanum manganites (LSM), strontium doped lanthanum ferrites (LSF), and strontium doped lanthanum cobalt iron oxides (LSCF).

A study by Matsuzaki (J. Electrochemical Society, 148(2) A126-A131 (2001)) evaluated Cr poisoning effects on varied cathode and electrolyte compositions. LSM electrode resistance to Cr poisoning was largely dependent on the electrolyte with which the LSM electrode was prepared. For example, the degradation rates were lower at the interfaces of LSM/samarium doped ceria (SDC) and LSM/strontium doped lanthanum gallates (LSGM) than at the interfaces of LSM/yttria-stabilitzed zirconia (YSZ) and LSM/scandia-stabilized zirconia (ScSZ). For a SDC electrolyte, the degradation rate of a LSCF cathode is much lower than LSM or strontium doped praseodymium manganites (PSM) cathodes.

A study by Cruse (Fuel Cell Seminar Abstract, 65-68, 2004) showed that the Cr tended to accumulate at the cathode/electrolyte interfaces. Additionally, the Cr content in the cathode was correlated with oxygen vacancy for LSM and LSF materials such that (LSM<LSF<LSFsub).

Additionally, research by Larring (J. Electrochemical Soc., 147 (9) 3251-56 (2000)) showed that Mn—Co spinel coating for metallic interconnects might reduce the volatility of Cr species. The study evaluated cathode materials including LSM, LSF, and LSCF. Use of the Mn—Co spinel coating on the metallic interconnects reduced, but did not eliminate, the Cr deposition at the electrode/electrolyte interfaces. Although the degradation rate was reduced with the coating, it was still evident.

Lastly, attempts have been made to form a barrier layer between the metallic interconnect and SOFC electrodes to trap the Cr species. Recent studies using Mn_{1.5}Co₁₅O₄ coatings on ferritic alloys showed that the material shows promise as Cr barrier (Electrochemical Solid-State Letters, 8(3) A168-A170 (2005)). No Cr migration across the spinel coating was evident after 6 months of heating and thermal cycling.

Although these previous studies have shown promise in reducing Cr formation and migration, they do not completely eliminate the problem of cathode performance degradation through Cr poisoning. Problems remaining include (1) the fact that protective coatings cannot provide complete protection of all metallic surfaces; (2) that even a small amount of Cr species can result in rapid decay of traditional cathode performance; and (3) a failure to address the compatibility between protective coatings and cathode materials in SOFC.

Accordingly, there is a need for a new cathode material that will resist the effects of Cr poisoning and improve performance durability.

### SUMMARY OF THE INVENTION

This invention addresses the above described needs by providing an electrode comprising AₓB₃₋ₓO₄, wherein A and B are selected from the group consisting of Mn, Co, Fe, Cr, Cu, V, and Ni.

More particularly, this invention also encompasses a solid oxide electrochemical device comprising the above-described electrode as a cathode in a fuel cell (or anode in electrolyzer), an anode (or a cathode in electrolyzer), and an electrolyte disposed between the anode and the cathode.

In addition, this invention encompasses a method for making a solid oxide electrochemical device comprising first arranging the electrochemical device so that the electrolyte is disposed between the anode and the cathode, the anode is connected to the anode side interconnect, and the cathode is connected to the cathode side interconnect, the cathode of the fuel cell (or anode of the electrolyzer) comprising AₓB₃₋ₓO₄.

Other objects, features, and advantages of this invention will be apparent from the following detailed description, drawing, and claims.

### BRIEF DESCRIPTION OF DRAWINGS

FIG. 1 is an exploded perspective view of a solid oxide electrochemical device made in accordance with an embodiment of the present invention.

FIG. 2 is a schematic illustration of the solid oxide electrochemical device of FIG. 1 in operation.

### DETAILED DESCRIPTION OF EMBODIMENTS

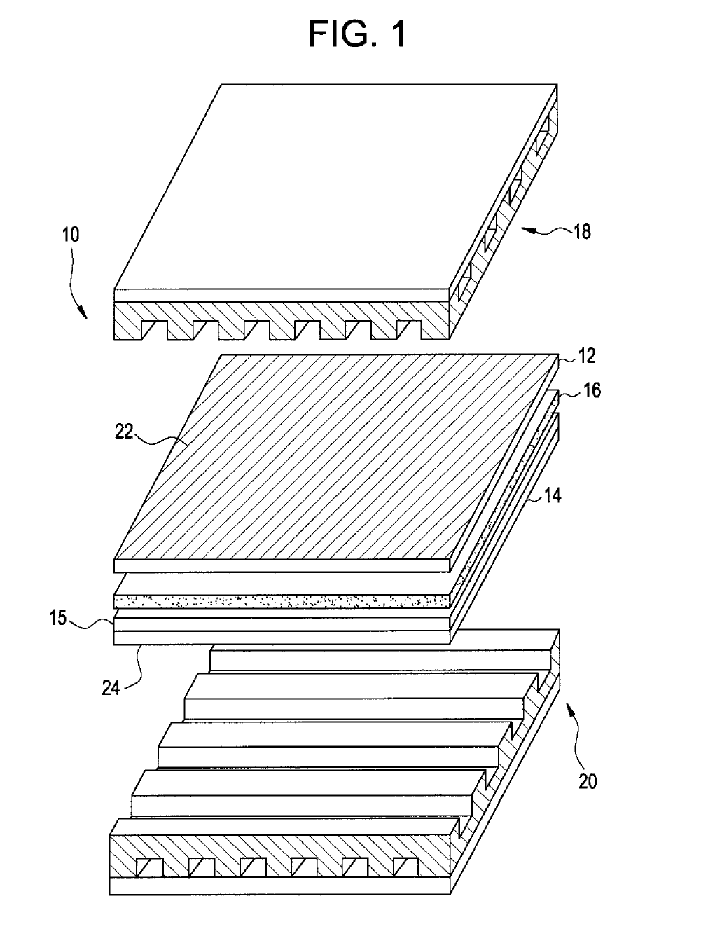

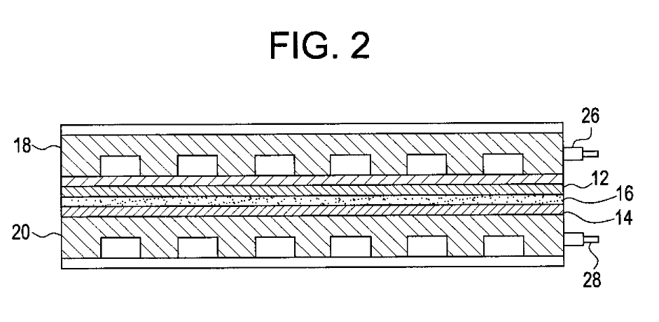

As summarized above, this invention encompasses an electrode for use in a solid oxide electrochemical device comprising AₓB₃₋ₓO₄. Embodiments of this invention are described in detail below and illustrated in FIGS. 1-2.

A single solid oxide electrochemical device 10 having improved integrity made in accordance with an embodiment of this invention is illustrated in FIG. 1. More particularly, the solid oxide electrochemical device 10 in FIG. 1 is an SOFC, but it should be understood that this invention also encompasses solid oxide electrolyzers and electrochemical pumps. Generally, the SOFC 10 comprises an anode 12, a cathode 14, a solid electrolyte 16 disposed between the anode 12 and the cathode 14, and metallic interconnects 18 and 20.

The anode 12 is in the form of a thin ceramic layer and is suitable for solid oxide fuel cell operation. Desirably, the anode 12 comprises Ni-cermet, such as a Ni/yttria-stabilized zirconia (YSZ), Ni/ceria, and Ni/scandia-stabilized zirconia (ScSZ). In another embodiment, the anode 12 comprises Cu/ceria cermet. In yet another embodiment, the anode 12 comprises conducting ceramics, such as doped (La,Sr)TiO₃ mixed with doped ceria, doped LaNiO₃, doped LaCrO₃, and doped niobates. Such anodes are well known to those skilled in the art. While these materials are desirable, it should be understood that other materials may be used.

The cathode 14 comprises AₓB_{3-z}O₄, wherein A and B are selected from the group consisting of Mn, Co, Fe, Cr, Cu, V, and Ni. It is desirable that x is within a range greater than 0 and less than 3. Preferably, x ranges from about 0.5 to about 2.5. Most preferably, x equals 1.5. These cathode 14 materials have the desired material properties for a solid oxide fuel cell 10. For example, the composition Mn_{1.5}Co_{1.5}O₄ has a conductivity of approximately 100 S/cm at 800° C. and a coefficient of thermal expansion of approximately 11.5×10⁻⁶ K⁻¹ from temperatures of 20° C. to 800° C.

In another embodiment, the cathode 14 further comprises at least one conducting electrolyte material. Ionic conducting electrolyte materials include doped zirconia, doped ceria, doped lanthanum gallate, and doped Ba(Sr)Ce(Zr)O₃. While these materials are desirable, it should be understood that additional electrolyte materials may be used.

In yet another embodiment, the cathode 14 further comprises at least one catalyst. The catalyst may comprise a precious metal and conducting ceramic. Precious metals include Pt, Pd, Ru, Ag, and Rh. Conducting ceramics include lanthanum cobalites, lanthanum ferrites, and lanthanum manganites.

In an illustrative example of a cathode 14, a cathode paste is formed from a mixture of 50 wt % Mn_{1.5}Co_{1.5}O₄ and 50 wt % yttria-stablized zirconia electrolyte ceramic powders and proper amount of organic vehicles such as V-006 and alpha terpineol. The cathode 14 is made by screen-printing the paste onto the electrolyte 16 surface followed by drying and firing the component at elevated temperatures of about 900° C. to about 1300° C. These techniques are well known to those skilled in the art.

The electrolyte 16 is disposed between the anode 12 and the cathode 14 and desirably comprises a material selected from the group consisting of doped zirconia, doped ceria, doped lanthanum gallate, and doped Ba(Sr)Ce(Zr)O₃, although other electrolyte materials may also be used. Such electrolyte materials are well known to those skilled in the art.

An interlayer 15 may be disposed between the cathode 14 and electrolyte 16. The interlayer is preferably doped ceria, such as samarium doped ceria or gadolium-doped ceria.

The metallic interconnects 18 and 20 are made of electrically conducting materials such as a metal plate or metal foil. Desirably, they are made of metals such as SS446 (stainless steel), SS430 (stainless steel), AL453, E-Brite available from Allegheny Ludlum Corporation, Crofer 22 available from ThyssenKrupp VDM, or Fecralloy available from Goodfellow.

Bonding agents 22 and 24 may be used to enhance the mechanical integrity of the bond between the anode 12 and anode side of the metallic interconnect 18 and cathode 14 and cathode side of the metallic interconnect 20. The cathode bonding agent 24 has a material composition substantially similar to the cathode material 14, preferably comprising a manganese spinet compound.

FIG. 2 illustrates the solid oxide fuel cell of FIG. 1 in operation. In operation, the SOFC 10 is equipped with an gas inlet 26 for feeding gas along the gas flow path between the anode 12 and the anode side of the metallic interconnect 18. The solid oxide fuel cell 10 is also equipped with another gas inlet 28 for feeding another gas along another flow path between the cathode 14 and the cathode side of the metallic interconnect 20.

This invention also encompasses a method for making a solid oxide fuel cell 10 comprising an anode 12, a cathode 14, an electrolyte 16, and metallic interconnects 18 and 20. Conventionally, the solid oxide fuel cell 10 is stacked so that the interconnect 18 of one cell connects to the electrode 12 or 14 of a neighboring cell. Contact materials, such as a contact paste and screen, can be used to improve the contact and reduce the contact resistance between the electrode 12 or 14 and the interconnect 18. For example, a Ni screen/mesh/foam can be placed between a Ni-YSZ anode and a metallic interconnect. Alternatively, a brazing process can be used to create brazing joints between the electrodes 12 and 14 and metallic interconnects 18 and 20, improving both the mechanical and electrical contacts. Most brazing processes require a reducing atmosphere or vacuum environment to form a reliable joint and prevent excessive oxidation of the metallic interconnects 18 and 20. However, most existing cathode 14 materials will decompose under reducing atmospheres and lose their function. The cathode 14 comprising AₓB₃₋ₓO₄ as a high tolerance to the redox process, permitting use of a single reducing atmosphere during assembly and initial heat treatment processes of the electrochemical device 10.

When a AₓB₃₋ₓO₄ cathode 14 is exposed to a reducing atmosphere, a portion of the cathode material will be reduced and decomposed into oxides (denoted as AₐO_{y} and B_{b}O_{z}) and/or element metals (A and B) in the reducing atmosphere. It is therefore desirable to oxidize the cathode 14 in the electrochemical device 10 in an oxidizing atmosphere to convert any AₐO_{y}, B_{b}O_{z}, A, and B formed during the brazing process back to AₓB₃₋ₓO₄. The oxidizing atmosphere is preferably an environment with temperatures from about 700° C. to about 900° C., which are typical of electrochemical device 10 operating temperatures.

The present invention utilizes a new cathode composition comprising AₓB₃₋ₓO₄ to reduce the detrimental effect of Cr poisoning on cathode material and performance and simplify the method of making a solid oxide electrochemical device with improved interconnect and electrode bonds.

It should be understood that the foregoing relates to particular embodiments of the present invention, and that numerous changes may be made therein without departing from the scope of the invention as defined from the following claims.

We claim:

1. An electrode for use in a solid oxide electrochemical device comprising AₓB₃₋ₓO₄, wherein A and B are selected from the group consisting of Mn, Co, Fe, Cr, Cu, V, and Ni.

2. An electrode as in claim 1 further comprising at least one ionic conducting electrolyte material.

3. An electrode as in claim 2 wherein the at least one ionic conducting electrolyte material is selected from the group consisting of doped zirconia, doped ceria, doped lanthanum gallate, and doped Ba(Sr)Ce(Zr)O₃.

4. An electrode as in claim 1 further comprising at least one catalyst.

5. An electrode as in claim 4 wherein the at least one catalyst is a precious metal.

6. An electrode as in claim 5 wherein the precious metal is selected from the group consisting of Pt, Pd, Ag, Ru, and Rh.

7. An electrode as in claim 4 wherein the at least one catalyst is a conducting ceramic.

8. An electrode as in claim 1 wherein x ranges from an amount greater than 0 and less than 3.

9. An electrode as in claim 1 wherein x ranges from about 0.5 to about 2.5.

10. An electrode as in claim 1 wherein x equals 1.5.

11. An electrode as in claim 1 wherein the solid oxide electrochemical device is a solid oxide fuel cell.

12. An electrode as in claim 1 wherein the solid oxide electrochemical device is a solid oxide electrolyzer.

13. An electrode as in claim 1 wherein the solid oxide electrochemical device is a electrochemical pump.

14. A solid oxide fuel cell comprising:
a cathode comprising AₓB₃₋ₓO₄, wherein A and B are selected from the group consisting of Mn, Co, Fe, Cr, Cu, V, and Ni;
an anode;
electrolyte disposed between the anode and the cathode; and
a metallic interconnect electrically connecting the cathode of one cell to the anode of a second cell.

15. The solid oxide electrochemical device as in claim 14 wherein x ranges from about 0 to about 3.

16. The solid oxide electrochemical device as in claim 14 wherein x ranges from about 0.5 to about 2.5.

17. A method of making a solid oxide electrochemical device comprising a first electrode comprising AₓB₃₋ₓO₄ wherein A and B are selected from the group consisting of Mn, Co, Fe, Cr, Cu, V, and Ni, a second electrode, an electrolyte disposed between said electrodes, and a metallic interconnect, the method comprising the steps of:
brazing the second electrode to the metallic interconnect in a reducing atmosphere or vacuum environment; and
oxidizing the solid oxide electrochemical device in a oxidizing atmosphere to convert any AₐO_{y}, B_{b}O_{z}, A, and B formed during the brazing step back to AₓB₃₋ₓO₄.

18. A method as in claim 17 wherein the oxidizing atmosphere is an environment with a temperature from about 700° C. to about 900° C.

19. A method as in claim 17 wherein the step of brazing further comprises reducing the second electrode while exposing both electrodes to a reducing atmosphere.

20. A method as in claim 18 wherein the second electrode comprises NiO and Yttria-stabilized zirconia.
